(19) United States
(12) Patent Application Publication
(10) Pub. No.: US 2008/0311493 A1
(43) Pub. Date: Dec. 18, 2008

(54) INKLESS REIMAGEABLE PRINTING PAPER AND METHOD

(75) Inventors: Tyler B. Norsten, Oakville (CA); Gabriel Iftime, Mississauga (CA); Peter M. Kazmaier, Mississauga (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/762,176

(22) Filed: Jun. 13, 2007

(51) Int. Cl. G03C 1/00; G03C 11/00

(52) U.S. Cl. 430/19; 250/492.1; 430/270.1; 430/286.1

(57) ABSTRACT

An image forming medium includes a substrate and an imaging layer coated on or inpregnated into said substrate, where the imaging layer includes a photochromic material and an optional intermolecular hydrogen bond stabilizer, dispersed in a polymeric binder, where the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

### CROSS-REFERENCE TO RELATED APPLICATIONS

Disclosed in commonly assigned U.S. patent application Ser. No. 11/123,163, filed May 6, 2005, is an image forming medium, comprising a polymer, a photochromic compound containing chelating groups embedded in the polymer, and a metal salt, wherein molecules of the photochromic compound are chelated by a metal ion from the metal salt.

Disclosed in commonly assigned U.S. patent application Ser. No. 10/835,518, filed Apr. 29, 2004, is an image forming method comprising: (a) providing a reimageable medium comprised of a substrate and a photochromic material, wherein the medium is capable of exhibiting a color contrast and an absence of the color contrast; (b) exposing the medium to an imaging light corresponding to a predetermined image to result in an exposed region and a non-exposed region, wherein the color contrast is present between the exposed region and the non-exposed region to allow a temporary image corresponding to the predetermined image to be visible for a visible time; (c) subjecting the temporary image to an indoor ambient condition for an image erasing time to change the color contrast to the absence of the color contrast to erase the temporary image without using an image erasure device; and (d) optionally repeating procedures (b) and (c) a number of times to result in the medium undergoing a number of additional cycles of temporary image formation and temporary image erasure.

Disclosed in commonly assigned U.S. patent application Ser. No. 10/834,722, filed Apr. 29, 2004, is a reimageable medium comprising: a substrate; and a photochromic material, wherein the medium is capable of exhibiting a color contrast and an absence of the color contrast, wherein the medium has a characteristic that when the medium exhibits the absence of the color contrast and is then exposed to an imaging light corresponding to a predetermined image to result in an exposed region and a non-exposed region, the color contrast is present between the exposed region and the non-exposed region to form a temporary image corresponding to the predetermined image that is visible for a visible time, wherein the medium has a characteristic that when the temporary image is exposed to an indoor ambient condition for an image erasing time, the color contrast changes to the absence of the color contrast to erase the temporary image in all of the following: (i) when the indoor ambient condition includes darkness at ambient temperature, (ii) when the indoor ambient condition includes indoor ambient light at ambient temperature, and (iii) when the indoor ambient condition includes both the darkness at ambient temperature and the indoor ambient light at ambient temperature, and wherein the medium is capable of undergoing multiple cycles of temporary image formation and temporary image erasure.

Disclosed in commonly assigned U.S. patent application Ser. No. 11/220,803, filed Sep. 8, 2005, is an image forming medium, comprising: a substrate; and an imaging layer comprising a photochromic material and a polymer binder coated on said substrate, wherein the photochromic material exhibits a reversible homogeneous-heterogeneous transition between a colorless state and a colored state in the polymer binder.

Disclosed in commonly assigned U.S. patent application Ser. No. 11/220,572, filed Sep. 8, 2005, is an image forming medium, comprising: a substrate; and a mixture comprising a photochromic material and a solvent wherein said mixture is coated on said substrate, wherein the photochromic material exhibits a reversible homogeneous-heterogeneous transition between a colorless state and a colored state in the solvent.

Disclosed in commonly assigned U.S. patent application Ser. No. 11/123,163, filed May 6, 2005, is an image forming medium, comprising a polymer; and a photochromic compound containing chelating groups embedded in the polymer; and a metal salt; wherein molecules of the photochromic compound are chelated by a metal ion from the metal salt.

Disclosed in commonly assigned U.S. patent application Ser. No. 11/093,993, filed Mar. 20, 2005, is a reimageable medium, comprising: a substrate having a first color; a photochromic layer adjacent to the substrate; a liquid crystal layer adjacent to the photochromic layer, wherein the liquid crystal layer includes a liquid crystal composition; and an electric field generating apparatus connected across the liquid crystal layer, wherein the electric field generating apparatus supplies a voltage across the liquid crystal layer.

Disclosed in commonly assigned U.S. patent application Ser. No. 10/834,529, filed Apr. 29, 2004, is a reimageable medium for receiving an imaging light having a predetermined wavelength scope, the medium comprising: a substrate; a photochromic material capable of reversibly converting among a number of different forms, wherein one form has an absorption spectrum that overlaps with the predetermined wavelength scope; and a light absorbing material exhibiting a light absorption band with an absorption peak, wherein the light absorption band overlaps with the absorption spectrum of the one form.

The entire disclosure of the above-mentioned applications are totally incorporated herein by reference.

### TECHNICAL FIELD

This disclosure is generally directed to a substrate, method, and apparatus for inkless printing on reimageable paper. More particularly, in embodiments, this disclosure is directed to an inkless reimageable printing substrate, such as inkless printing paper utilizing a composition that is imageable and eraseable by heat and light, such as comprising a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light. Imaging is conducted by applying UV light to the imaging material to cause a color change, and erasing is conducted by applying visible light and/or heat to the imaging material to reverse the color change. Other embodiments are directed to inkless printing methods using the inkless printing substrates, and apparatus and systems for such printing.

### BACKGROUND

Inkjet printing is a well-established market and process, where images are formed by ejecting droplets of ink in an image-wise manner onto a substrate. Inkjet printers are widely used in home and business environments, and particularly in home environments due to the low cost of the inkjet printers. The inkjet printers generally allow for producing high quality images, ranging from black-and-white text to photographic images, on a ride range of substrates such as standard office paper, transparencies, and photographic paper.

However, despite the low printer costs, the cost of replacement inkjet cartridges can be high, and sometimes higher than the cost of the printer itself. These cartridges must be replaced frequently, and thus replacement costs of the ink cartridges is a primary consumer complaint relating to inkjet printing. Reducing ink cartridge replacement costs would thus be a significant enhancement to inkjet printing users.

In addition, many paper documents are promptly discarded after being read. Although paper is inexpensive, the quantity of discarded paper documents is enormous and the disposal of these discarded paper documents raises significant cost and environmental issues. Accordingly, there is a continuing desire for providing a new medium for containing the desired image, and methods for preparing and using such a medium. In aspects thereof it would be desirable to be reusable, to abate the cost and environmental issues, and desirably also is flexible and paper-like to provide a medium that is customarily acceptable to end-users and easy to use and store.

Although there are available technologies for transient image formation and storage, they generally provide less than desirable results for most applications as a paper substitute. For example, alternative technologies include liquid crystal displays, electrophoretics, and gyricon image media. However, these alternative technologies may not in a number of instances provide a document that has the appearance and feel of traditional paper, while providing the desired reimageability.

Imaging techniques employing photochromic materials, that is materials which undergo reversible or irreversible photoinduced color changes are known, for example, U.S. Pat. No. 3,961,948 discloses an imaging method based upon visible light induced changes in a photochromic imaging layer containing a dispersion of at least one photochromic material in an organic film forming binder.

These and other photochromic (or reimageable or electric) papers are desirable because they can provide imaging media that can be reused many times, to transiently store images and documents. For example, applications for photochromic based media include reimageable documents such as, for example, electronic paper documents. Reimageable documents allow information to be kept for as long as the user wants, then the information can be erased or the reimageable document can be re-imaged using an imaging system with different information.

Although the above-described approaches have provided reimageable transient documents, there is a desire for reimageable paper designs that provide longer image life-times, and more desirable paper-like appearance and feel. For example, while the known approaches for photochromic paper provide transient visible images, the visible images are very susceptible to UV, such as is present in both ambient interior light and more especially in sun light, as well as visible light. Due to the presence of this UV and visible light, the visible images are susceptible to degradation by the UV light, causing the unimaged areas to darken and thereby decrease the contrast between the desired image and the background or unimaged areas.

That is, a problem associated with transient documents is the sensitivity of the unimaged areas to ambient UV-VIS light (such as <420 nm) where the photochromic molecule absorbs. Unimaged areas become colored after a period of time, decreasing the visual quality of the document, because the contrast between white and colored state is reduced. One approach, described in the above-referenced U.S. patent application Ser. No. 10/834,529, is to stabilize the image against light of wavelength <420 nm by creating a band-pass window for the incident light capable of isomerising (i.e. inducing coloration) in the material, centered around 365 nm. However, the unimaged areas of the documents still are sensitive to UV-VIS light of wavelength centered around 365 nm.

Another problem generally associated with known transient documents is that common photochromic materials such as merocyanines (the colored state isomer form of spiropyrans) are not significantly stable over time to ambient heat and light, and thus tend to revert back to the colorless state through both thermal and visible light. It is known that some photochromic materials, such as the merocyanines, can form molecular aggregation of the charged molecules in solution and thus result in long lived colored states due to the stabilization of the colored-ionic state. However, formation of such stabilized aggregates in the solid state, such as in a dried layer comprising a polymer binder, is much more difficult, and thus it is more difficult to achieve the stable long lived colored states.

### SUMMARY

It is desirable for some uses that an image formed on a reimageable medium such as a transient document remains stable for extended time periods, without the image or image contrast being degraded by exposure to ambient UV light. However, it is also desired that the image can be erased when desired, to permit reimaging of the medium. It is also desired that the imaging medium be similar to conventional paper, that is, having the look and feel of conventional paper. This generally requires that the imaging composition of the imaging medium be a solid layer, not a layer of a solvent-based system. Electronic paper documents should also maintain a written image for as long as the user needs to view it, without the image being degraded by ambient heat or light. The image may then be erased or replaced with a different image by the user on command.

Common merocyanines (the spiropyran isomer responsible for creating image contrast in some current transient documents) are not significantly stable and revert back to the colorless state through both thermal and visible light. The usefulness of such documents could be increased if the stability of the isomer was more stable, particularly against ambient heat and light. It has been discovered that this increased stability can be provided by using properly designed photochromes that can form inter- or intra-molecular hydrogen bonds that can stabilize the colored state. This creates a thermally and/or photochemically stable image. The resulting image can be erased by disrupting the hydrogen bonding through the application of thermal energy (heat) and the colored state can be driven back to the noncolored state both thermally and/or with visible light.

The present disclosure addresses these and other needs, in embodiments, by providing a reimageable image forming medium utilizing a composition that is both imageable and eraseable by heat and light, and which comprises an imaging composition that comprises a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light. Imaging is conducted by applying UV light to the imaging material to cause a color change, and erasing is conducted by applying visible light and optionally heat to the imaging material to reverse the color change. The present disclosure in other embodiments provides an inkless printing method using the reimageable inkless printing substrates, and apparatus and systems for such printing.

The present disclosure thereby provides a printing media, method, and printer system for printing images without using ink or toner. The paper media has a paper-like look and feel and carries a special imageable composition and it is printed and can be erased with light and/or heat. The paper media thus allows image formation and erasure using a printer that does not require ink or toner replacement, and instead images the paper using a UV light source, such as a LED.

In an embodiment, the present disclosure provides a reimageable image forming medium, comprising

a substrate; and

an imaging layer coated on or impregnated into said substrate, wherein the imaging layer comprises a photochromic material and an optional intermolecular hydrogen bond stabilizer, dispersed in a polymeric binder,

wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

In another embodiment, the present disclosure provides a method of making a reimageable image forming medium, comprising applying an imaging layer composition to a substrate, wherein the imaging layer comprises a photochromic material and an optional intermolecular hydrogen bond stabilizer, dispersed in a polymeric binder,

wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

In another aspect, the present disclosure provides a method of forming an image, comprising:

providing an image forming medium comprising:
a substrate; and
an imaging layer coated on or impregnated into said substrate, wherein the imaging layer comprises a photochromic material and an optional intermolecular hydrogen bond stabilizer, dispersed in a polymeric binder; and

exposing the image forming medium to UV irradiation of a first wavelength in an imagewise manner,

wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

The imaging method can be conducted, for example, using an imaging system, comprising:

the above image forming medium; and

a printer comprising two irradiation sources, wherein one irradiation source sensitizes the photochromic material to convert the photochromic material from a colorless state to a colored state the other irradiation source converts the photochromic material from a colored state to a colorless state.

### BRIEF DESCRIPTION OF THE DRAWINGS

FIG. 1 shows exemplary hydrogen bonding interactions.

FIG. 2 shows a reaction scheme for an Example of the disclosure.

FIG. 3 shows a reaction scheme for an Example of the disclosure.

FIG. 4 shows a reaction scheme for an Example of the disclosure.

FIG. 5 shows a reaction scheme for an Example of the disclosure.

### DETAILED DESCRIPTION OF EXEMPLARY EMBODIMENTS

Generally, in various exemplary embodiments, there is provided an inkless reimageable paper or image forming medium formed using a composition that is imageable and eraseable by heat and light, such as comprising a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer. Exposing the imaging layer to UV light causes the photochromic material to easily convert from the colorless state to a stable colored state. The formed hydrogen bonding helps stabilize the ionic form of the photochromic material, and thus locks in the colored state when the light is removed. Likewise, exposing the imaging layer to visible light and optional heat causes the hydrogen bonds in the photochromic material to break, and thus to convert back from the colored state to the colorless state. The formed hydrogen bonding provides a more stable colored-ionic state of the photochromic material, which makes the colored state more stable against heat and light in the ambient environment and provides a more prolonged visible image, but which can be erased on demand using a suitable erasing step. The composition thus exhibits a reversible transition between a clear state and a colored state in the image forming medium. By a colored state, in embodiments, refers to for example, the presence of visible wavelengths; likewise, by a colorless state, in embodiments, refers to for example, the complete or substantial absence of visible wavelengths.

Photochromism and thermochromism are defined as the reversible photocoloration of a molecule from exposure to light (electromagnetic radiation) and heat (thermal radiation) based stimuli respectively. Typically photochromic molecules undergo structural and/or electronic rearrangements when irradiated with UV light that converts them to a more conjugated colored state. In the case of purely photochromic molecules, the colored state can typically be converted back to their original colorless state by irradiating them with visible light. Dithienylethenes and fulgides are examples of photochromic molecules that generally exhibit thermal bi-stability. If the isomerization is also capable thermally (by applying heat), as is the case in spiropyrans, azabenzenes, schiff bases and the like, the molecules are classified as both thermochromic and photochromic. This is shown in the following reaction:

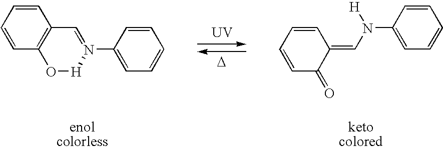

Photochromic compounds are typically bi-stable in absence of light whereas photochromic-thermochromic compounds will transform in the absence of light through a thermal process to the thermodynamically more stable state. To create a stable reimageable erase-on-demand document it is desired to stabilize the colored state, specifically to ambient conditions (light and temperature) that the document will encounter.

The present disclosure is thus distinguished from a solvent-based system, where the photochromic material, such as a spiropyran/merocyanine material, is simply dissolved or dispersed in a suitable solvent. For example, merocyanines (the isomer responsible for creating image contrast in spiropyran/merocyanine material systems) are not significantly stable to ambient conditions, and tend to quickly and easily revert back to the colorless state through both thermal and visible light activation.

In embodiments, to overcome this problem, the image forming medium generally comprises an imaging layer coated on or impregnated in a suitable substrate material, or sandwiched or laminated between a first and a second substrate material (i.e., a substrate material and an overcoat layer). The imaging layer can include any suitable photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer.

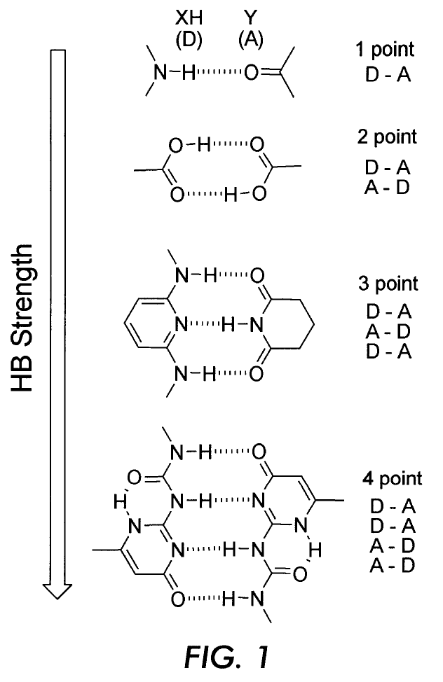

Hydrogen bonding generally connects two atoms, here denoted atoms X and Y, that have electronegativities larger than that of hydrogen. For example, hydrogen bonding typically connects such atoms as C, N, O, F, P, S, Cl, Br, Se, and I. See FIG. 1, which shows exemplary hydrogen bonding between materials X and Y, with both intramolecular hydrogen bonding and intermolecular hydrogen bonding. As shown in FIG. 1, the XH group is generally referred to as the “proton donor” (D) and the Y atom is generally called the “proton acceptor” (A) group. The strength of the hydrogen bond increases with an increase in the dipole moment of the X-H bond and the lone pair on the Y atom. Hydrogen bonding strength also increases when hydrogen bonds are arranged in a linear (typically planar) fashion so as to create multi-point hydrogen bonding interactions.

Hydrogen bonds that are within a molecule are referred to as intramolecular hydrogen bonds, and if the hydrogen bonds occur between molecules they are referred to as intermolecular hydrogen bonds. The strength of hydrogen bonding (typically ranging from 2-20 kcal/mol) is on the scale such that a reasonable amount of thermal energy (typically ranging from 20-300° C.) can be used to disrupt both inter- and intra- molecular hydrogen bond interactions without destroying the molecules, and then have the ability to reform upon cooling. This ability to form, break, and re-form hydrogen bonds provides reversibility, such as shown in the following scheme:

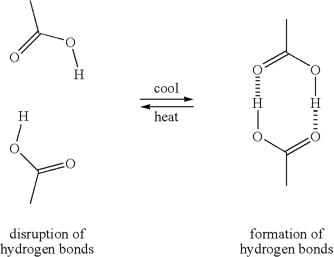

Such hydrogen bonds have been known to stabilize the colored forms of merocyanines. See, for example, “Stabilization of the merocyanine form of photochromic compounds in fluoro alcohols is due to a hydrogen bond”, Chem. Commun., 1998, 2685-2686. These studies were conducted in the solution state and they were typically very weak single point interactions and as such the lifetime of the colored states were not extended indefinitely. In another example polar hydrogen bond containing semi-solid gel matrices can be used to stabilized the colored form of spirooxazines, for instance see “Photochromism of Spirooxazine-Doped Gels”, J. Phys. Chem., 1996, 100, 9024-9031. In embodiments of the disclosure describe the incorporation of designed hydrogen bonding interactions as a stabilizing force for the colored state in photochromic and/or thermochromic compounds in solid state matrices for reimageable erase-on-demand document applications.

The photochromic material and optional intermolecular hydrogen bond stabilizer generally are any suitable materials that enable stabilization of colored forms of the photochromic material. The photochromic material and optional intermolecular hydrogen bond stabilizer are thus selected such that when in the colored state, the materials form intra- or inter-molecular hydrogen bonds, to stabilize the colored form of the photochromic material, which in turn provides the desired stability to the formed image. The materials are also selected such that the photochromic material and optional intermolecular hydrogen bond stabilizer can readily switch from a first clear or colorless state to a second colored state upon exposure to light such as UV light, and can readily switch from the second colored state back to the first clear or colorless state by breaking the hydrogen bonds by exposure to heat and optionally visible light. Both the hydrogen bonding interactions and the color state change in embodiments are reversible, and thus the image can be “erased” and the image forming medium returned to a blank state.

In embodiments, any suitable composition can be used for forming the imaging layer. For example, the imaging layer can comprise a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer. The active imaging materials can be dispersed in any suitable medium for forming the imaging layer, such as being dispersed in a solvent, a solution, a polymer binder, or the like; provided in the form of microencapsulated materials; incorporated in an enclosed matrix to hold the imaging composition in place; and the like. However, in embodiments, the active imaging materials are provided such that they form a solid imaging layer on a substrate. In embodiments, the image forming reaction can be reversible an almost unlimited number of times, because the isomerization and hydrogen bonding changes between the clear and colored states do not consume the materials over time.

Any suitable photochromic material can be used, where the photochromic material exhibits the required hydrogen bond formation and color change properties upon exposure to heat and optionally light. The photochromic material may exhibit hydrogen bonding properties, where one of the isomer forms, such as the colored form, forms one, two, three, four, five or more hydrogen bonds per molecule, where the hydrogen bonds can be entirely within its molecule (intramolecular), can be with an optional intermolecular hydrogen bond stabilizer (intermolecular), or a combination of these forms (intramolecular and intermolecular). Thus, for example, the photochromic material and optional intermolecular hydrogen bond stabilizer can form one, two, three, four, five or more point (hydrogen bond) interactions per photochromic material molecule. In embodiments where the hydrogen bonds are only intramolecular, it is desired that at least two, such as two, three, four, five, or more, point (hydrogen bond) interactions per photochromic material are formed. In embodiments where the hydrogen bonds are only intermolecular, it is desired that at least one, such as one, two, three, four, five, or more, point (hydrogen bond) interactions per photochromic material are formed. In embodiments where the hydrogen bonds are intramolecular and intermolecular, it is desired that at least one, such as one, two, three, four, five, or more, of each type of point (hydrogen bond) interactions per are formed photochromic material.

The photochromic material may exhibit photochromism, which is a reversible transformation of a chemical species induced in one or both directions by absorption of an electromagnetic radiation between two forms having different absorption spectra. The first form is thermodynamically stable and may be induced by absorption of light such as ultraviolet light to convert to a second form. The second form in embodiments is stable, and forms stable structures with hydrogen bonds. The reverse reaction from the second form to the first form may occur, for example, thermally, or by absorption of light such as visible light, or both. In embodiments, both heat and light are used to reverse the reaction, where the heat disrupts the hydrogen bonding of the colored state, and the light causes the color change. Various exemplary embodiments of the photochromic material may also encompass the reversible transformation of the chemical species among three or more forms in the event it is possible that reversible transformation occurs among more than two forms. The photochromic material of embodiments may be composed of one, two, three, four, or more different types of photochromic materials, each of which has reversibly interconvertible forms. As used herein, the term “photochromic material” refers to all molecules of a specific species of the photochromic material, regardless of their temporary isomeric forms. For example, where the photochromic material is the species spiropyran, which exhibits isomeric forms as spiropyran and merocyanine, at any given moment the molecules of the photochromic material may be entirely spiropyran, entirely merocyanine, or a mixture of spiropyran and merocyanine. In various exemplary embodiments, for each type of photochromic material, one form may be colorless or weakly colored and the other form may be differently colored.

The photochromic material may be any suitable photochromic material that is useful in providing photochromic paper including, for example, organic photochromic materials. In embodiments, the suitable photochromic materials are those that are capable of forming stabilizing hydrogen bonds in the colored state, such as those that contain heteroatoms with lone pairs capable of acting as proton acceptors or hydrogen atoms capable of acting as proton donors. Examples of photochromic materials include spiropyrans and related compounds like spirooxazines and thiospiropyrans, benzo and naphthopyrans (chromenes), stilbene, azobenzenes, bisimidazols, spirodihydroindolizines, quinines, perimidinespirocyclohexadienones, viologens, fulgides, fulgimides, diarylethenes, hydrazines, anils, aryl disulfides, aryl thiosulfonates and the like. In the aryl disulfides and aryl thiosulfonates, suitable aryl groups include phenyl, naphthyl, phenanthrene, anthracene, substituted groups thereof, and the like. These materials can variously undergo heterocyclic cleavage, such as spiropyrans and related compounds; undergo homocyclic cleavage such as hydrazine and aryl disulfide compounds; undergo cis-trans isomerization such as azo compounds, stilbene compounds and the like; undergo proton or group transfer phototautomerism such as photochromic quinines; undergo photochromism via electro transfer such as viologens; and the like. Specific examples of materials include:

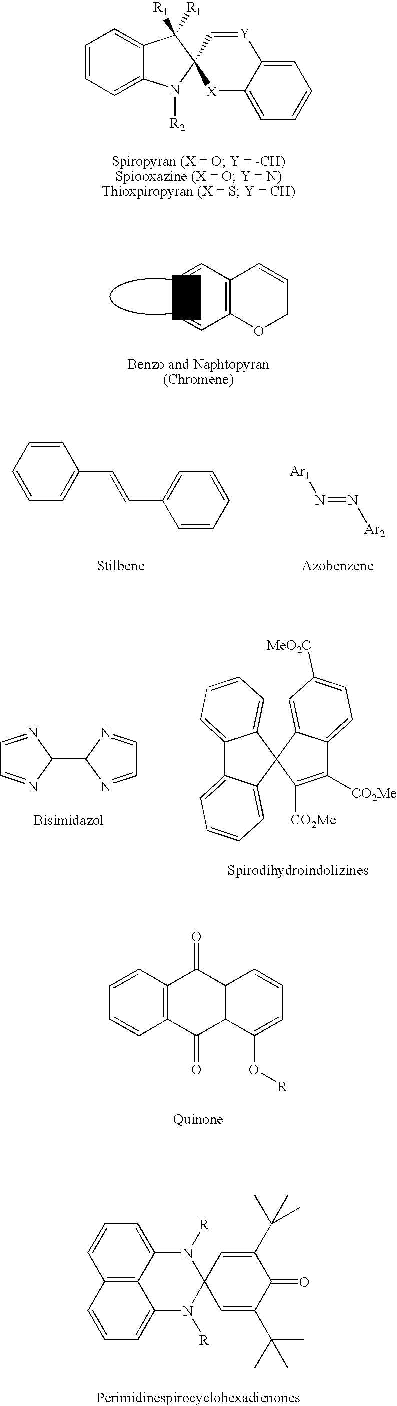

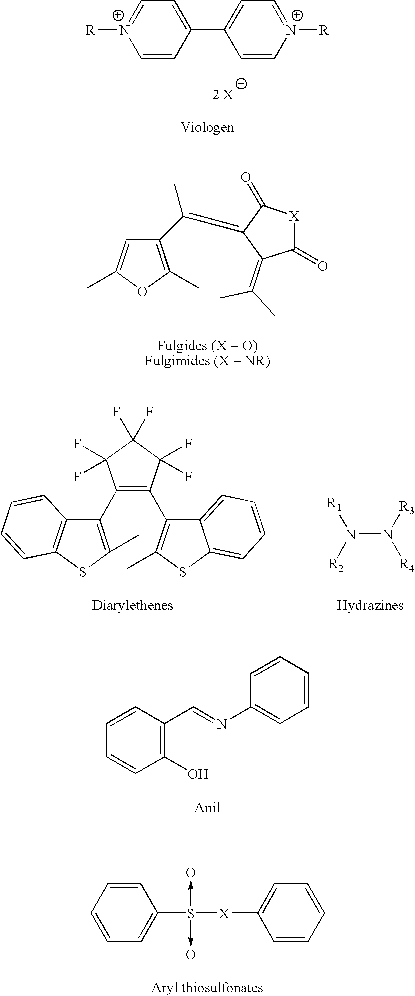

In these structures, the various R groups (i.e., R, R₁, R₂, R₃, R₄) can independently be any suitable group including but not limited to hydrogen; alkyl, such as methyl, ethyl, propyl, butyl, and the like, including cyclic alkyl groups, such as cyclopropyl, cyclohexyl, and the like, and including unsaturated alkyl groups, such as vinyl (H₂C═CH—), allyl (H₂C═CH—CH₂—), propynyl (HC≡C—CH₂—), and the like, where for each of the foregoing, the alkyl group has from 1 to about 50 or more carbon atoms, such as from 1 to about 30 carbon atoms; aryl, including phenyl, naphthyl, phenanthrene, anthracene, substituted groups thereof, and the like, and having from about 6 to about 30 carbon atoms such as from about 6 to about 20 carbon atoms; arylalkyl; such as having from about 7 to about 50 carbon atoms such as from about 7 to about 30 carbon atoms; silyl groups; nitro groups; cyano groups; halide atoms, such as fluoride, chloride, bromide, iodide, and astatide; amine groups, including primary, secondary, and tertiary amines; hydroxy groups; alkoxy groups, such as having from 1 to about 50 carbon atoms such as from 1 to about 30 carbon atoms; aryloxy groups, such as having from about 6 to about 30 carbon atoms such as from about 6 to about 20 carbon atoms; alkylthio groups, such as having from 1 to about 50 carbon atoms such as from 1 to about 30 carbon atoms; arylthio groups, such as having from about 6 to about 30 carbon atoms such as from about 6 to about 20 carbon atoms; aldehyde groups; ketone groups; ester groups; amide groups; carboxylic acid groups; sulfonic acid groups; and the like. The alkyl, aryl, and arylalkyl groups can also be substituted with groups such as, for example, silyl groups; nitro groups; cyano groups; halide atoms, such as fluoride, chloride, bromide, iodide, and astatide; amine groups, including primary, secondary, and tertiary amines; hydroxy groups; alkoxy groups, such as having from 1 to about 20 carbon atoms such as from 1 to about 10 carbon atoms; aryloxy groups, such as having from about 6 to about 20 carbon atoms such as from about 6 to about 10 carbon atoms; alkylthio groups, such as having from 1 to about 20 carbon atoms such as from 1 to about 10 carbon atoms; arylthio groups, such as having from about 6 to about 20 carbon atoms such as from about 6 to about 10 carbon atoms; aldehyde groups; ketone groups; ester groups; amide groups; carboxylic acid groups; sulfonic acid groups; and the like. Ar₁ and Ar₂ can independently be any suitable aryl or aryl-containing group including but not limited to phenyl, naphthyl, phenanthrene, anthracene, and the like, and substituted groups thereof including any of the substitutions mentioned above for the alkyl, aryl, and arylalkyl groups. X in the spiropyran formula is a suitable heteroatom such as N, O, S, and the like. Y can be —N— or —CH—. X⁻ in the Viologen formula can be, for example, F⁻, Cl⁻, Br⁻, I⁻, BF₄⁻, PF₆⁻, B(C₆H₅)₄⁻ and the like. X⁻ in the aryl thiosulfonate can be, for example, —O—, S, —NH— and the like.

If desired, the above photochromic materials may also be modified, for example, by including additional functional groups. For example, suitable functional groups that can be added to the photochromic material include, but are not limited to, SO₃H groups, carboxylic acid (CO₂H) groups, CONHR, CONR₂ groups (where the R groups can be the same or different), CO₂R groups, COX groups or SO₂X groups (where X is a halogen, such as fluorine or chlorine), sulfonamide groups, and the like. The sulfonamide groups can also be unsubstituted (SO₂NH₂) or substituted (SO₂NR₂, where the R groups can include H, alkyl, aryl, arylalkyl groups and the like as described above for the photochromic materials, and can be the same or different). In another embodiment, sulfonic acid salts (—SO₃M) and carboxylic acid salts (COOM) can be suitable functional groups for achieving stabilization through hydrogen bonding of the colored isomer. In these salts, M represents a positive counter ion and can be, for example, metal ions such as Na⁺, Li⁺, Mg²⁺, Ca²⁺, Al³⁺, Zn²⁺, Cu⁺, Cu²⁺ as well as ammonium ions of the general formula, R⁴N⁺ ions where R represents organic radicals that can be identical or different. Such functional groups can be readily incorporated into the photochromic materials by known processes. In some embodiments, the functional group is a carboxylic acid group (—COOH). In another embodiment the photochrome can be attached to a polymer that also contains a suitable hydrogen bond stabilizing functionality for that photochrome.

The imaging material also can include an optional intermolecular hydrogen bond stabilizer. Such intermolecular hydrogen bond stabilizer can be any suitable compound that, in the presence of the photochromic material, leads to hydrogen bond formation with at least one of the isomer forms of the photochromic material. Examples of suitable intermolecular hydrogen bond stabilizers include materials, such as compounds or polymers, having one or more hydrogen bond donating or accepting groups selected from hydroxy (ROH), ether, ROR, amino (R₂NH, RNH₂), RSH, carboxyl (such as RCOOH, RCOSH), carbonyl (ROR), amido R₂NCOR, and the like R can be alkyl or aryl. In embodiments, the hydrogen bond donating group OH or NH. Specific examples of such groups are urethane (carbamate) groups, inverted urethanes, urea groups (such as R₂N—C(═O)—NR₂ where each R independently represents H or a straight or branched, substituted or unsubstituted alkyl or aryl group of from 1 to about 20 or more carbon atoms), amide group, maleimide group, amine (such as NR₃ where each R independently represents H or a straight or branched, substituted or unsubstituted alkyl or aryl group of from 1 to about 20 or more carbon atoms), thio-urethane, thiourea, isothiourea, hydroxy esters, hydroxyl, phosphoryl, sulfoxide, sulfonyl, ester, ureido, cyano, imine, pyridyl, imidizole and the like. It is particularly desired that the hydrogen bond stabilizer have a complementary hydrogen bond interaction to the colored photochromic species. For instance a one point hydrogen bond (A) interaction on the photochrome requires at least a 1 point (D) hydrogen bond interaction on the stabilizer. Likewise, a two point hydrogen bond (AA) or (DA) interaction on the photochrome requires at least a complementary 2 point (DD) or (AD) hydrogen bond interaction on the stabilizer respectively. Further, a three point hydrogen bond (DAD), (DDA) or (DDD) interaction on the photochrome requires at least a complementary 3 point (ADA), (AAD) or (AAA) hydrogen bond interaction on the stabilizer respectively. Similar complementary interactions between photochrome and stabilizer are likewise desirable for higher point hydrogen bonding interactions. It can also be desirable that either bifurcated of trifurcated hydrogen bonding interactions exist between the stabilizing matrix and the photochromic species. Various suitable hydrogen bond stabilizers are described, for example, in U.S. Pat. No. 6,906,118, the entire disclosure of which is incorporated herein by reference.

Although not limited, in embodiments it is desired that the intermolecular hydrogen bond stabilizer has one, two, three, four, five or more hydrogen bond donating groups per molecule. For example, a single molecule of an intermolecular hydrogen bond stabilizer can have one, two, three, four, five or more hydrogen bond donating groups, while a polymer chain containing the intermolecular hydrogen bond stabilizer can have one, two, three, four, five or more hydrogen bond donating groups, such as up to about 10, 15, 20, 30, 40, 50 or more hydrogen bond donating groups. At least two, three, four, five or more hydrogen bond donating groups per molecule are desired in embodiments where increased hydrogen bond strength, and thus stabilization, is desired.

In embodiments, it is desired that the photochromic material and optional intermolecular hydrogen bond stabilizer, when present, are selected such that they exhibit or obtain sufficient mobility under heat and/or light irradiation for the photochromic material to convert from one of the colored or colorless form to the other, and for hydrogen bonds to form or break either within the photochromic material or between the photochromic material and optional intermolecular hydrogen bond stabilizer.

The image forming materials (photochromic material and optional intermolecular hydrogen bond stabilizer) are dispersed in any suitable carrier, such as solvent, an additional polymer binder, or the like. In embodiments where the intermolecular hydrogen bond stabilizer may be a polymer that can also function as a binder material, an additional binder or carrier may not be required, and the polymer can serve the function of providing a film-forming binder. In other embodiments, a separate film-forming polymer binder can be provided.

Suitable examples of polymer binders include, but are not limited to, polyethylene and polystyrene, which by definition contain no hydrogen bond donor or acceptor atoms and therefore behave purely as a binder, or other donor and acceptor containing polymers such as, polyalkylacrylates like polymethyl methacrylate (PMMA), polycarbonates, oxidized polyethylene, polypropylene, polyisobutylene, polystyrenes, poly(styrene)-co-(ethylene), polysulfones, polyethersulfones, polyarylsulfones, polyarylethers, polyolefins, polyacrylates, polyvinyl derivatives, cellulose derivatives, polyurethanes, polyamides, polyimides, polyesters, silicone resins, epoxy resins, polyvinyl alcohol, polyacrylic acid, and the like. Copolymer materials such as polystyrene-acrylonitrile, polyethylene-acrylate, vinylidenechloride-vinylchloride, vinylacetate-vinylidene chloride, styrene-alkyd resins are also examples of suitable binder materials. The copolymers may be block, random, graft, dendridic or alternating copolymers. In some embodiments, polymethyl methacrylate or a polystyrene is the polymer binder, in terms of their cost and wide availability.

Phase change materials can also be used as the polymer binder. Phase change materials are known in the art, and include for example crystalline polyethylenes such as Polywax® 2000, Polywax® 1000, Polywax® 500, and the like from Baker Petrolite, Inc.; oxidized wax such as X-2073 and Mekon wax, from Baker-Hughes Inc.; crystalline polyethylene copolymers such as ethylene/vinyl acetate copolymers, ethylene/vinyl alcohol copolymers, ethylene/acrylic acid copolymers, ethylene/methacrylic acid copolymers, ethylene/carbon monoxide copolymers, polyethylene-b-polyalkylene glycol wherein the alkylene portion can be ethylene, propylene, butylenes, pentylene or the like, and including the polyethylene-b-(polyethylene glycol)s and the like; crystalline polyamides; polyester amides; polyvinyl butyral; polyacrylonitrile; polyvinyl chloride; polyvinyl alcohol hydrolyzed; polyacetal; crystalline poly(ethylene glycol); poly(ethylene oxide); poly(ethylene therephthalate); poly(ethylene succinate); crystalline cellulose polymers; fatty alcohols; ethoxylated fatty alcohols; and the like, and mixtures thereof.

In embodiments, the imaging composition can be applied in one form, and dried to another form for use. Thus, for example, the imaging composition comprising photochromic material and binder polymer may be dissolved or dispersed in a solvent for application to or impregnation into a substrate, with the solvent being subsequently evaporated to form a dry layer.

In general, the imaging composition can include the imaging material and carrier (polymer binder) in any suitable amounts, such as from about 5 to about 99.5 percent by weight carrier, such as from about 30 to about 70 percent by weight carrier, and from about 0.05 to about 50 percent by weight each of photochromic material and optional intermolecular hydrogen bond stabilizer, such as from about 0.1 to about 5 percent each of photochromic material and optional intermolecular hydrogen bond stabilizer by weight.

For applying the imaging layer to the image forming medium substrate, the image forming layer composition can be applied in any suitable manner. For example, the image forming layer composition can be mixed and applied with any suitable solvent or polymer binder, and subsequently hardened or dried to form a desired layer. Further, the image forming layer composition can be applied either as a separate distinct layer to the supporting substrate, or it can be applied so as to impregnate into the supporting substrate.

The image forming medium may comprise a supporting substrate, coated or impregnated on at least one side with the imaging layer. As desired, the substrate can be coated or impregnated on either only one side, or on both sides, with the imaging layer. When the imaging layer is coated or impregnated on both sides, or when higher visibility of the image is desired, an opaque layer may be included between the supporting substrate and the imaging layer(s) or on the opposite side of the supporting substrate from the coated imaging layer. Thus, for example, if a one-sided image forming medium is desired, the image forming medium may include a supporting substrate, coated or impregnated on one side with the imaging layer and coated on the other side with an opaque layer such as, for example, a white layer. Also, the image forming medium may include a supporting substrate, coated or impregnated on one side with the imaging layer and with an opaque layer between the substrate and the imaging layer. If a two-sided image forming medium is desired, then the image forming medium may include a supporting substrate, coated or impregnated on both sides with the imaging layer, and with at least one opaque layer interposed between the two coated imaging layers. Of course, an opaque supporting substrate, such as conventional paper, may be used in place of a separate supporting substrate and opaque layer, if desired.

Any suitable supporting substrate may be used. For example, suitable examples of supporting substrates include, but are not limited to, glass, ceramics, wood, plastics, paper, fabrics, textile products, polymeric films, inorganic substrates such as metals, and the like. The plastic may be for example a plastic film, such as polyethylene film, polyethylene terephthalate, polyethylene naphthalate, polystyrene, polycarbonate, polyethersulfone. The paper may be, for example, plain paper such as XEROX® 4024 paper, ruled notebook paper, bond paper, silica coated papers such as Sharp Company silica coated paper, Jujo paper, and the like. The substrate may be a single layer or multi-layer where each layer is the same or different material. In embodiments, the substrate has a thickness ranging for example from about 0.3 mm to about 5 mm, although smaller or greater thicknesses can be used, if desired.

When an opaque layer is used in the image forming medium, any suitable material may be used. For example, where a white paper-like appearance is desired, the opaque layer may be formed from a thin coating of titanium dioxide, or other suitable material like zinc oxide, inorganic carbonates, and the like. The opaque layer can have a thickness of, for example, from about 0.01 mm to about 10 mm, such as about 0.1 mm to about 5 mm, although other thicknesses can be used.

If desired, a further overcoating layer may also be applied over the applied imaging layer. The further overcoating layer may, for example, be applied to further adhere the underlying layer in place over the substrate, to provide wear resistance, to improve appearance and feel, and the like. The overcoating layer can be the same as or different from the substrate material, although in embodiments at least one of the overcoating layer and substrate layer is clear and transparent to permit visualization of the formed image. The overcoating layer can have a thickness of, for example, from about 0.01 mm to about 10 mm, such as about 0.1 mm to about 5 mm, although other thicknesses can be used. However, in embodiments, an overcoating layer is not used, so as to allow easy evaporation of water formed during the imaging step, in a post-imaging heating step. For example, if desired or necessary, the coated substrate can be laminated between supporting sheets such as plastic sheets.

In embodiments where the imaging material is coated on or impregnated into the substrate, the coating can be conducted by any suitable method available in the art, and the coating method is not particularly limited. For example, the imaging material can be coated on or impregnated into the substrate by dip coating the substrate into a solution of the imaging material composition followed by any necessary drying, or the substrate can be coated with the imaging composition to form a layer thereof. Similarly, the protective coating can be applied by similar methods.

In its method aspects, the present disclosure involves providing an image forming medium comprised of a substrate and an imaging layer comprising a photochromic material and optional intermolecular hydrogen bond stabilizer dispersed in a polymeric binder, which composition can be provided as a dry coating onto or into the substrate. To provide separate writing and erasing processes, imaging is conducted by applying a first stimulus, such as UV light irradiation, to the imaging material to cause a color change, and erasing is conducted by applying a second, different stimulus, such as UV or visible light irradiation, and optionally heat, to the imaging material to reverse the color change. Thus, for example, the imaging layer as a whole could be sensitive at a first (such as UV) wavelength that causes the photochromic material to convert from a clear to a colored state, while the imaging layer as a whole could be sensitive at a second, different (such as visible) wavelength that causes the photochromic material to convert from the colored back to the clear state.

In embodiments, heating can be applied to the imaging layer before or at the same time as the light irradiation, for either the writing and/or erasing processes. However, in embodiments, heating is not required for the writing process, as such stimuli as UV light irradiation are sufficient to cause the color change from colorless to colored and the formation of the desired hydrogen bonds, while heating may be desired for the erasing process to assist in increasing material mobility for speeding the color change from colored to colorless and the breaking of the hydrogen bonds. When used, the heat raises the temperature of the imaging composition, particularly the photochromic material, to raise the mobility of the imaging composition and thus allow easier and faster conversion from one color state to the other. The heating can be applied before or during the irradiation, if the heating causes the imaging composition to be raised to the desired temperature during the irradiation. Any suitable heating temperature can be used, and will depend upon, for example, the specific imaging composition used. For example, the heating can be conducted to raise the polymer binder to at or near its glass transition temperature or melting point, such as within about 5° C., within about 10° C., or within about 20° C. of the glass transition temperature or melting point, although it is desired in certain embodiments that the temperature not exceed the melting point so as to avoid undesired movement or flow of the polymer materials on the substrate.

The different stimuli, such as different light irradiation wavelengths, can be suitably selected to provide distinct writing and erasing operations. For example, in one embodiment, the photochromic material is selected to be sensitive to UV light to cause isomerization from the clear state to the colored state with formation of hydrogen bonds, but to be sensitive to visible light and/or heat to cause breaking of the hydrogen bonds and isomerization from the colored state to the clear state. In other embodiments, the writing and erasing wavelengths are separated by at least about 10 nm, such as at least about 20 nm, at least about 30 nm, at least about 40 nm, at least about 50 nm, or at least about 100 nm. Thus, for example, if the writing wavelength is at a wavelength of about 360 nm, then the erasing wavelength is desirably a wavelength of less than about 350 nm or greater than about 370 nm. Of course, the relative separation of sensitization wavelengths can be dependent upon, for example, the relatively narrow wavelengths of the exposing apparatus.

In a writing process, the image forming medium is exposed to an imaging light having an appropriate activating wavelength, such as a UV light source such as a light emitting diode (LED), in an imagewise fashion. The imaging light supplies sufficient energy to the photochromic material to cause the photochromic material to convert, such as isomerize, from a clear state to a colored state to produce a colored image at the imaging location, and for the photochromic material to interact to form hydrogen bonds to lock in the image. The amount of energy irradiated on a particular location of the image forming medium can affect the intensity or shade of color generated at that location. Thus, for example, a weaker intensity image can be formed by delivering a lesser amount of energy at the location and thus generating a lesser amount of colored photochromic unit, while a stronger intensity image can be formed by delivering a greater amount of energy to the location and thus generating a greater amount of colored photochromic unit. When suitable photochromic material, optional intermolecular hydrogen bond stabilizer, polymer binder, and irradiation conditions are selected, the variation in the amount of energy irradiated at a particular location of the image forming medium can thus allow for formation of grayscale images, while selection of other suitable photochromic materials can allow for formation of full color images.

Once an image is formed by the writing process, the formation of hydrogen bonds within the imaging materials stabilizes the image. That is, the hydrogen bonded photochromic isomer is more stable to ambient heat and light, and thus exhibits greater long-term stability. The image is thereby “frozen” or locked in, and cannot be readily erased in the absence of a specific second stimuli. The imaging substrate thus provides a reimageable substrate that exhibits a long-lived image lifetime, but which can be erased as desired and reused for additional imaging cycles.

In an erasing process, the writing process is essentially repeated, except that a different stimuli, such as a different wavelength irradiation light, such as visible light, is used, and when the photochromic material is heated such as to a temperature at or near a glass transition, melting, or boiling point temperature of the carrier material. The erasing process causes the formed hydrogen bonds to break and the photochromic unit to convert, such as isomerize, from a colored state to a clear state to erase the previously formed image at the imaging location. The erasing procedure can be on an image-wise fashion or on the entire imaging layer as a whole, as desired. The heating step is optional, in that certain compositions can be provided that are erased upon only exposure to the selected stimulus such as light wavelength, while other compositions can be provided that are more robust or thermally stable and can be erased only upon exposure to the selected stimulus such as light wavelength under a heating condition.

The separate imaging lights used to form the transient image and erase the transient image may have any suitable predetermined wavelength scope such as, for example, a single wavelength or a band of wavelengths. In various exemplary embodiments, the imaging lights are an ultraviolet (Uv) light and a visible light each having a single wavelength or a narrow band of wavelengths. For example, the UV light can be selected from the UV light wavelength range of about 200 nm to about 475 nm, such as a single wavelength at about 365 nm or a wavelength band of from about 360 nm to about 370 nm. For forming the image, as well as for erasing the image, the image forming medium may be exposed to the respective imaging or erasing light for a time period ranging from about 10 milliseconds to about 5 minutes, particularly from about 30 milliseconds to about 1 minute. The imaging and erasing light may have an intensity ranging from about 0.1 mW/cm² to about 100 mW/cm², particularly from about 0.5 mW/cm² to about 10 mW/cm².

In various exemplary embodiments, imaging light corresponding to the predetermined image may be generated for example by a computer or a Light Emitting Diode (LED) array screen and the image is formed on the image forming medium by placing the medium on or in proximity to the LED screen for the desired period of time. In other exemplary embodiments, a UV Raster Output Scanner (ROS) may be used to generate the UV light in an image-wise pattern. This embodiment is particularly applicable, for example, to a printer device that can be driven by a computer to generate printed images in an otherwise conventional fashion. That is, the printer can generally correspond to a conventional inkjet printer, except that the inkjet printhead that ejects drops of ink in the imagewise fashion can be replaced by a suitable UV light printhead that exposes the image forming medium in an imagewise fashion. In this embodiment, the replacement of ink cartridges is rendered obsolete, as writing is conducted using a UV light source. Other suitable imaging techniques that can be used include, but are not limited to, irradiating a UV light onto the image forming medium through a mask, irradiating a pinpoint UV light source onto the image forming medium in an imagewise manner such as by use of a light pen, and the like.

For erasing an image in order to reuse the imaging substrate, in various exemplary embodiments, the substrate can be exposed to a suitable imaging light, to cause the image to be erased. Such erasure can be conducted in any suitable manner, such as by exposing the entire substrate to the erasing light at once, exposing the entire substrate to the erasing light in a successive manner such as by scanning the substrate, or the like. In other embodiments, erasing can be conducted at particular points on the substrate, such as by using a light pen, or the like.

According to various exemplary implementations, the color contrast that renders the image visible to an observer may be a contrast between, for example two, three or more different colors. The term “color” may encompass a number of aspects such as hue, lightness and saturation, where one color may be different from another color if the two colors differ in at least one aspect. For example, two colors having the same hue and saturation but are different in lightness would be considered different colors. Any suitable colors such as, for example, red, white, black, gray, yellow, cyan, magenta, blue, and purple, can be used to produce a color contrast as long as the image is visible to the naked eye of a user. However, in terms of desired maximum color contrast, a desirable color contrast is a dark gray or black image on a light or white background, such as a gray, dark gray, or black image on a white background, or a gray, dark gray, or black image on a light gray background.

In various exemplary embodiments, the color contrast may change such as, for example, diminish during the visible time, but the phrase “color contrast” may encompass any degree of color contrast sufficient to render an image discernable to a user regardless of whether the color contrast changes or is constant during the visible time.

An example is set forth hereinbelow and is illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

### Example 1

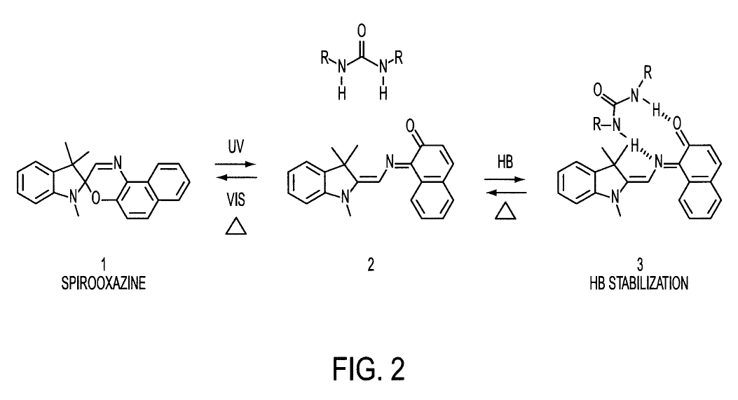

A methanol solution of a spirooxazine and a urea (or urea containing polymer) and polymethylmethacrylate polymer binder is prepared as an imaging composition. The solution is coated onto Xerox 4024 paper and allowed to dry. The paper is written by exposing desired areas to UV light (365 nm). The printed paper is readable for longer than a two day period of time when kept in ambient room light conditions. The said stabilizing chemical interactions are shown in FIG. 2. Formation of the colored form of the spirooxazine creates a rigid 2 point hydrogen bond proton acceptor (A) face (compound 2—imine nitrogen and keto oxygen). The urea (or urea containing polymer) contains a complementary rigid 2 point hydrogen bond proton donor (D) face and thus forms a stabilizing hydrogen bonded complex with the colored form (compound 3). Heat can be applied to the image to disrupt the hydrogen bonds and thermally erase the image while visible light and heat will also de-color the image.

### Example 2

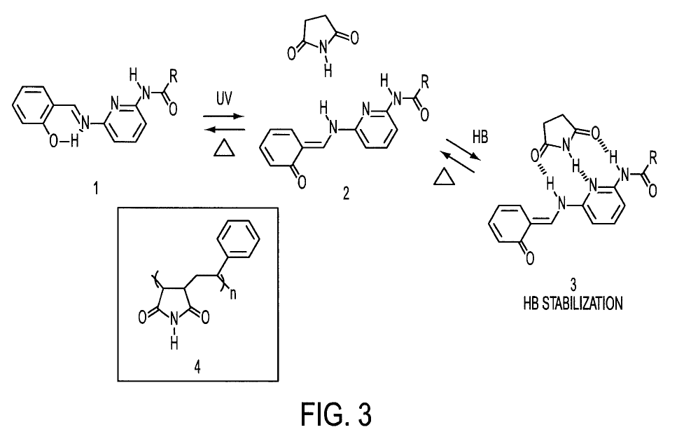

An imaging material coated substrate is formed as in Example 1, except that an appropriately designed Schiff base derivative (compound 1 in FIG. 3) and a maleimide derivative (or maleimide containing polymer) are used. The paper is written by exposing desired areas to UV light (365 nm). The printed paper is readable for longer than a two day period of time when kept in ambient room light conditions. The chemical interactions are shown in FIG. 3. Formation of the colored form of the Schiff base derivative creates a rigid 3 point hydrogen bond (DAD) face (compound 2). The maleimide derivative (or maleimide containing polymer such as compound 4) contains a complementary rigid 3 point hydrogen bond proton donor (ADA) face and thus forms a stabilizing hydrogen bonded complex with the colored form (compound 3). The maleimide containing polymer is described, for example, in “Supramolecular polymer interactions based on the alternating copolymer of styrene and Maleimide” Macromolecules, 1995, 28, 782-783. Heat can be applied to the image to disrupt the hydrogen bonds and thermally erase the image while visible light and heat will also de-color the image.

### Example 3

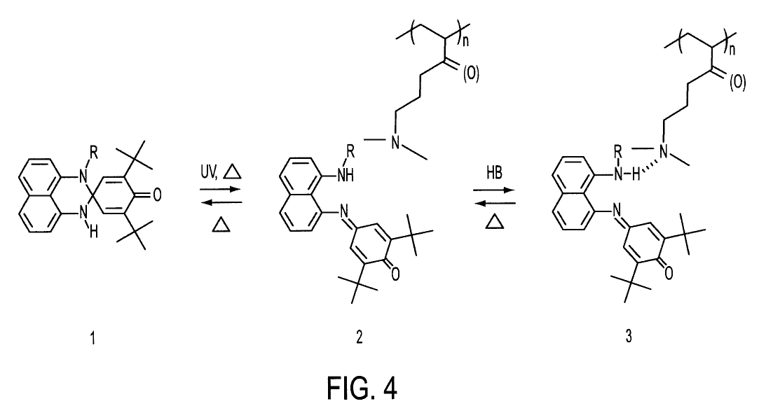

An imaging material coated substrate is formed as in Example 1, except that a perimidinespirocyclohexadienone (compound 1 in FIG. 4) and poly(N,N-dimethylaminoethylmethacrylate) are used. The paper is written by exposing desired areas to UV light (365 nm). The printed paper is readable for longer than a two day period of time when kept in ambient room light conditions. The chemical interactions are shown in FIG. 4. The perimidinespirocyclohexadienones undergoes a light induced intramolecular proton transfer to form the colored quinoid (compound 2). Further retardation of thermal fading can be accomplished by the addition of relatively strong bases such as triethylamine. Morpholine (or morpholine containing polymers) or hydroxide ion (or ionomeric hydroxide ion containing polymers) can also be used as the strong base. The result a stabilizing effect of the colored state as a result of intermolecular hydrogen bonding. See, for example, “Perimidinespirocyclohexadienones” in Organic Photochromic and Thermochromic Compounds, VI, Plenum Press, 1999, p 329. Heat can be applied to the image to disrupt the hydrogen bonds and thermally erase the image while visible light and heat will also de-color the image.

### Example 4

An imaging material coated substrate is formed as in Example 3, except that a perimidinespirocyclohexadienone (compound 1 in FIG. 4) and a tributylamine are used. Specifically, a toluene (2 liters) solution of perimidinespirocyclohexadienone (40 g), tributylamine (20.6 g; 1 molar equivalent) and PMMA (250 g) is prepared. The solution is then coated onto Xerox 4024 paper and allowed to dry. The paper is written by exposing desired areas to UV light (365 nm). The printed paper is readable for longer than a two day period of time when kept in ambient room light conditions. Heat can be applied to the image to disrupt the hydrogen bonds and thermally erase the image while visible light and heat will also de-color the image.

### Example 5

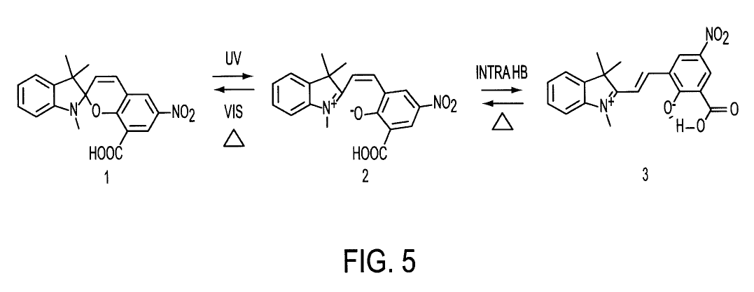

An imaging material coated substrate is formed as in Example 1, except that an appropriately designed spiropyran carboxylic acid derivative (compound 1 in FIG. 5) is used, without an intermolecular hydrogen bond stabilizer. The paper is written by exposing desired areas to UV light (365 nm). The printed paper is readable for longer than a two day period of time when kept in ambient room light conditions. The chemical interactions are shown in FIG. 5. The spiropyran carboxylic acid derivative when exposed to UV light creates an oxygen anion that immediately forms a strong intramolecular hydrogen bond to the proximal carboxylic acid proton thus stabilizing the colored state (compound 3). Heat can be applied to the image to disrupt the hydrogen bond and thermally erase the image while visible light and heat will also de-color the image.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An image forming medium, comprising
a substrate; and
an imaging layer coated on or impregnated into said substrate, wherein the imaging layer comprises a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

2. The image forming medium of claim 1, wherein the photochromic material forms hydrogen bonds and converts from a colorless state to a colored state upon irradiation with light of a first wavelength and breaks formed hydrogen bonds and converts from a colored state to a colorless state upon irradiation with heat or light of a second wavelength different from the first wavelength.

3. The image forming medium of claim 1, wherein the photochromic material forms at least two intramolecular hydrogen bonds per molecule.

4. The image forming medium of claim 1, wherein the intermolecular hydrogen bond stabilizer is present and the photochromic material forms at least one intermolecular hydrogen bond per molecule between the photochromic material and the intermolecular hydrogen bond stabilizer.

5. The image forming medium of claim 1, wherein the intermolecular hydrogen bond stabilizer is present and the photochromic material forms at least two hydrogen bonds per photochromic material molecule.

6. The image forming medium of claim 1, wherein the photochromic material is selected from the group consisting of a spiropyran compound, spirooxazine, thiospiropyran, a benzo compound, naphthopyran, stilbene, azobenzene, bisimidazol, spirodihydroindolizine, quinine, perimidinespirocyclohexadienone, viologen, fulgide, fulgimide, diarylethene, hydrazine, anil, aryl disulfide, aryl thiosulfonate, and Schiff bases.

7. The image forming medium of claim 1, wherein the photochromic material comprises at least one function group selected from the group consisting of SO₃H, COOH, CONR₂, CO₂R, COX, SO₂X, SO₂NH₂, SO₂NR₂, R⁴N⁺, SO₃M, and COOM,
wherein the R groups can be the same or different and represent H, alkyl, aryl, or arylalkyl groups having from 1 to about 50 carbon atoms; X is a halogen; and M represents a positive metal counter ion.

8. The image forming medium of claim 1, wherein the intermolecular hydrogen bond stabilizer is present and is a molecule or polymer having one or more hydrogen bond donating groups selected from the group consisting of OH, NH, NH₂, SH, COOH, and COSH.

9. The image forming medium of claim 1, wherein the intermolecular hydrogen bond stabilizer is present and is a molecule or polymer having one or more hydrogen bond donating groups selected from the group consisting of urethanes, inverted urethanes, R₂N—C(═O)—NR₂, R₂NCOR, where each R independently represents H or a straight or branched substituted or unsubstituted alkyl group of from 1 to about 20 carbon atoms, amides, maleimides, NR₃ where each R independently represents H or a straight or branched substituted or unsubstituted alkyl group of from 1 to about 20 carbon atoms), thio-urethane, thiourea, isothiourea, hydroxy esters, hydroxyl, phosphoryl, sulfoxide, sulfonyl, ester, ether, imine, ureido, pyridyl and cyano.

10. The image forming medium of claim 1, wherein the intermolecular hydrogen bond stabilizer is present and is a non-polymer molecule having one or more hydrogen bond donating groups per molecule.

11. The image forming medium of claim 1, wherein the intermolecular hydrogen bond stabilizer is present and is a polymer having one or more hydrogen bond donating groups per polymer chain.

12. The image forming medium of claim 11, wherein the intermolecular hydrogen bond stabilizer polymer also functions as a film-forming polymer.

13. The image forming medium of claim 1, wherein the polymeric binder is selected from the group consisting of polyalkylacrylates, polycarbonates, polyethylenes, oxidized polyethylene, polypropylene, polyisobutylene, polystyrenes, poly(styrene)-co-(ethylene), polysulfones, polyethersulfones, polyarylsulfones, polyarylethers, polyolefins, polyacrylates, polyvinyl derivatives, cellulose derivatives, polyurethanes, polyamides, polyimides, polyesters, silicone resins, epoxy resins, polyvinyl alcohol, polyacrylic acid, polystyrene-acrylonitrile, polyethylene-acrylate, vinylidenechloride-vinylchloride, vinylacetate-vinylidene chloride, styrene-alkyd resins, and mixtures thereof.

14. The image forming medium of claim 1, wherein the photochromic material is present in an amount of from about 0.01% to about 20% by weight of a total dry weight of the imaging layer.

15. The image forming medium of claim 1, wherein the intermolecular hydrogen bond stabilizer is present in an amount of from about 0.01% to about 95% by weight of a total dry weight of the imaging layer.

16. The image forming medium of claim 1, wherein the substrate is selected from the group consisting of glass, ceramic, wood, plastic, paper, fabric, textile, metals, plain paper, and coated paper.

17. A method of making an image forming medium, comprising applying an imaging layer composition to a substrate, wherein the imaging layer composition comprises a photochromic material and an optional intermolecular hydrogen bond stabilizer, dispersed in a polymeric binder, wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

18. The method of claim 17, wherein the applying comprises coating the imaging layer over the substrate or impregnating the imaging layer into the substrate.

19. A method of forming an image, comprising:
providing an image forming medium comprising:
a substrate; and
an imaging layer coated on or impregnated into said substrate, wherein the imaging layer comprises a photochromic material and an optional intermolecular hydrogen bond stabilizer, dispersed in a polymeric binder; and
exposing the image forming medium to UV irradiation of a first wavelength in an imagewise manner to form a visible image,
wherein the photochromic material reversibly forms intramolecular hydrogen bonds or reversibly forms intermolecular hydrogen bonds with the intermolecular hydrogen bond stabilizer, and thereby exhibits a reversible transition between a colorless state and a colored state in response to heat and light.

20. The method of claim 19, further comprising:
exposing the image forming medium bearing said image to light irradiation of a second wavelength in an imagewise manner, optionally while heating the photochromic material, wherein said light irradiation causes said hydrogen bonds to break and said photochromic material to change from the colored state to the colorless state; and
repeating the step of exposing the image forming medium to the UV irradiation of a first wavelength in an imagewise manner at least one additional time.

21. The method of claim 19, wherein the exposing is for a time period ranging from about 10 milliseconds to about 5 minutes at an intensity ranging from about 0.1 mW/cm² to about 100 mW/cm².

22. An imaging system, comprising:
the image forming medium of claim 1;
a printer comprising two irradiation sources, wherein one irradiation source sensitizes the photochromic material to convert the photochromic material from a colorless state to a colored state the other irradiation source converts the photochromic material from a colored state to a colorless state.
